(19) United States
(12) Patent Application Publication
(10) Pub. No.: US 2025/0178470 A1
(43) Pub. Date: Jun. 5, 2025

(54) CHARGE CONTROL DEVICE

(71) Applicant: TOYOTA JIDOSHA KABUSHIKI KAISHA, Toyota-shi (JP)

(72) Inventors: Ippei TAKESUE, Nisshin-shi (JP); Masashi KOBAYASHI, Toyota-shi (JP)

(73) Assignee: TOYOTA JIDOSHA KABUSHIKI KAISHA, Toyota-shi (JP)

(21) Appl. No.: 18/797,855

(22) Filed: Aug. 8, 2024

(30) Foreign Application Priority Data
Dec. 5, 2023 (JP) 2023-205422

(51) Int. Cl. B60L 53/62; B60L 58/12

(52) U.S. Cl. CPC B60L 53/62; B60L 58/12; B60L 2240/545

(57) ABSTRACT

A charge control device includes a control unit, and the control unit limits the power consumption of a battery temperature control actuator at the time of charging a vehicle to be equal to or less than an output limit of a charging station. The charge control device is capable of suppressing a decrease in SOC due to battery temperature control at the time of charging the vehicle.

### CROSS-REFERENCE TO RELATED APPLICATION

This application claims priority to Japanese Patent Application No. 2023-205422 filed on Dec. 5, 2023, incorporated herein by reference in its entirety.

### BACKGROUND

### 1. Technical Field

The present disclosure relates to a charge control device.

### 2. Description of Related Art

Japanese Unexamined Patent Application Publication No. 2023-117976 (JP 2023-117976 A) discloses a technique of limiting electric power for charging a battery so that the sum of the electric power for charging the battery and electric power consumption of a water heater does not exceed the maximum output of a charging station.

### SUMMARY

In the technique disclosed in JP 2023-117976 A, the electric power consumption by a battery temperature control actuator is not limited, and the electric power equal to or greater than the maximum output of the charging station is allowed to be consumed. Therefore, a state of charge (SOC) of a vehicle may be decreased even while the vehicle is being charged.

The present disclosure has been made in view of the above, and an object of the present disclosure is to provide a charge control device capable of suppressing a decrease in SOC due to battery temperature control while a vehicle is being charged.

A charge control device according to the present disclosure comprises: a controller, in which the controller limits electric power consumption of a battery temperature control actuator to equal to or less than an output limit of a charging station while a vehicle is being charged.

According to the present disclosure, it is possible to suppress a decrease in SOC due to battery temperature control while a vehicle is being charged.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a charge control device according to an embodiment;

FIG. 2 is a time chart showing the transition of the stand maximum power and the battery temperature control actuator power consumption of the conventional charge control device;

FIG. 3 is a time chart showing the transition of the maximum power of the stand, the power consumed by the battery temperature control actuator, and the permitted power for use in the battery temperature control application of the charge control device according to the embodiment; and

FIG. 4 is a flowchart illustrating a flow of a charging control method executed by the charge control device according to the embodiment.

### DETAILED DESCRIPTION OF EMBODIMENTS

A charge control device according to an embodiment of the present disclosure will be described with reference to the drawings. Incidentally, the constituent elements in the following embodiments include those that can be easily replaced by a person skilled in the art or those that are substantially the same.

### Charge Control Device

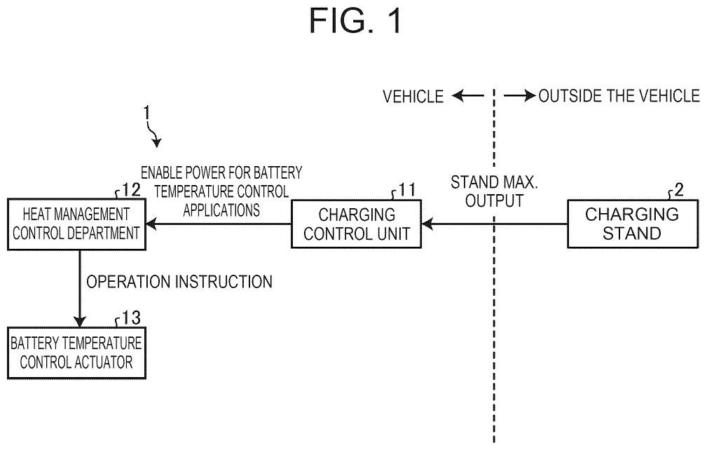

The configuration of the charge control device according to the embodiment will be described with reference to FIGS. 1 to 3. The charge control device according to the embodiment is mounted in, for example, a hybrid electric vehicle (HEV), a plug-in hybrid electric vehicle (PHEV), a battery electric vehicle (BEV), or the like.

As illustrated in FIG. 1, the charge control device 1 includes a charge control unit 11, a thermal management control unit 12, and a battery temperature control actuator 13.

The charge control unit 11 and the thermal management control unit 12 are realized by, for example, a processor including a central processing unit (CPU), and a memory (main storage unit) including a random access memory (RAM), a read only memory (ROM), and the like. Further, the charge control unit 11 and the thermal management control unit 12 limit the power consumption of the battery temperature control actuator 13 at the time of vehicle charging to be equal to or less than the output limit of the charging station 2 (for example, equal to or less than the maximum output).

Specifically, the charge control unit 11 acquires information on the maximum power that the charging station 2 can output (hereinafter, referred to as “stand maximum output information”) from the charging station 2 that is currently charging. Subsequently, the charge control unit 11 determines the maximum electric power that can be charged in consideration of the acquired maximum output of the stand, and calculates the electric power that is permitted to be used for the battery temperature control actuator 13 (hereinafter, referred to as “allowable electric power for use in battery temperature control”).

The thermal management control unit 12 instructs the battery temperature control actuator 13 to operate. Specifically, the thermal management control unit 12 operates the battery temperature control actuator 13 within the allowable power for use in battery temperature control calculated by the charge control unit 11.

The battery temperature control actuator 13 is for controlling the temperature of a battery of a vehicle (not shown). The battery temperature control actuator 13 adjusts the temperature of the battery based on an operation instruction from the thermal management control unit 12.

The charging station 2 is provided in, for example, a charging station. The charging station 2 includes a charging adapter or the like for charging the vehicle.

Here, the electric power that can be received by the battery (hereinafter, referred to as “battery receivable electric power”) depends on the temperature of the battery. Therefore, in the vehicle, the temperature of the battery is adjusted in order to improve the battery receivable power.

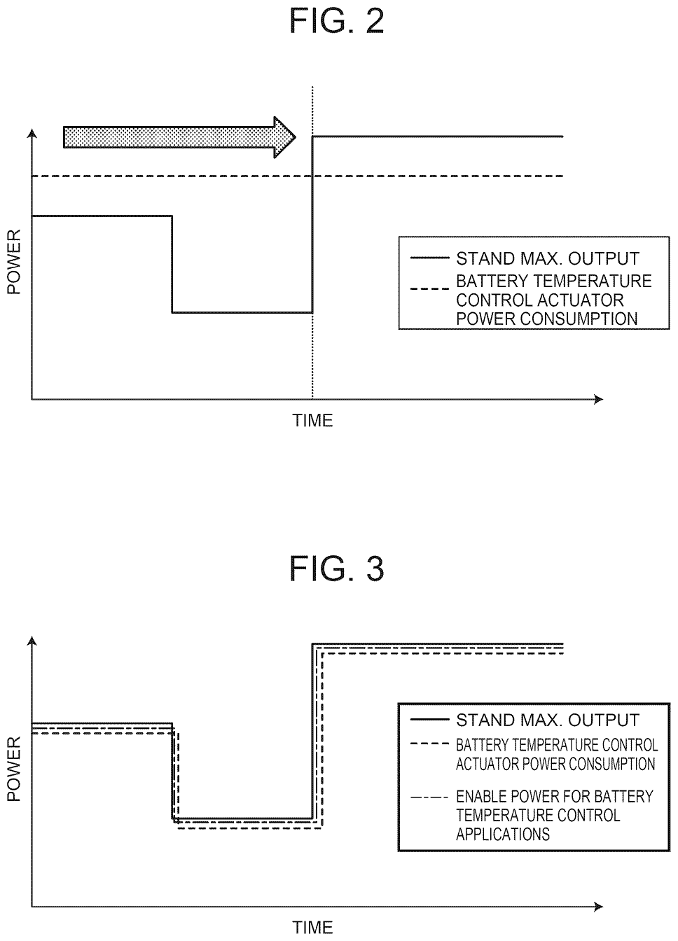

However, for example, as shown in FIG. 2, when the power consumed by the battery-temperature control actuator exceeds the maximum power of the stand of the charging station, SOC of the vehicle also decreases during charging. Therefore, in the charging control device according to the embodiment, for example, as shown in FIG. 3, by limiting the power consumption of the battery temperature control actuator 13 to be equal to or less than the maximum power consumption of the stand of the charging station 2, the power consumption from the battery is suppressed, and a decrease in SOC at the time of charging is suppressed.

### Charging Control Method

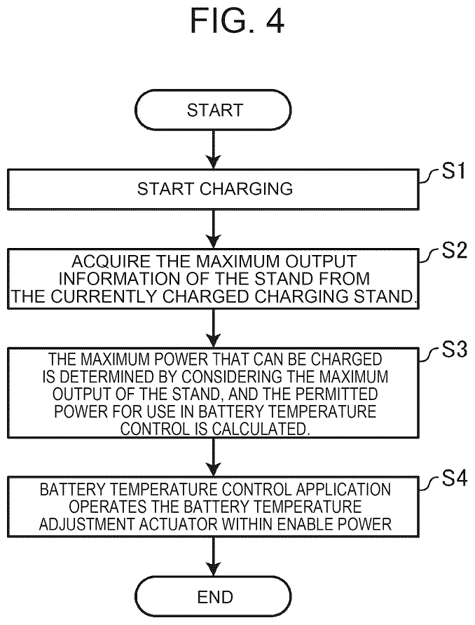

A flow of a charging control method executed by the charging control device according to the embodiment will be described with reference to FIG. 4.

First, the charge control unit 11 starts charging (S1). Subsequently, the charge control unit 11 acquires the maximum-output-data of the stand from the charging station 2 currently being charged (S2).

Subsequently, the charge control unit 11 determines the maximum power that can be charged by considering the acquired maximum power of the stand, and calculates the allowable power for use in the battery temperature control (S3). Subsequently, the thermal management control unit 12 operates (S4) the battery temperature control actuator 13 within the allowable power for use of the battery temperature control calculated by S3, and completes this process.

In addition, in S3, in addition to calculating the permitted power for use in the battery temperature control, the permitted power for use in the battery temperature control can be calculated by the following methods (1) to (4), for example.
(1) Based on the current output of the charging station 2, the allowable power for use in the battery temperature control is calculated.
(2) Based on the current sensor value/voltage sensor value at the end of the battery, the permitted power for use in the battery temperature control is calculated.
(3) Based on the current sensor value/voltage sensor value at the vehicle inlet end, the permitted power for use in battery temperature control is calculated.
(4) In addition to the above (1) to (3), the allowable battery temperature control use power is calculated in consideration of the charging power upper limit set value that can be set by the user.

According to the charge control device of the embodiment described above, it is possible to suppress a decrease in SOC caused by the temperature control of the batteries during the charge of the vehicles.

Further advantages and variations can be readily derived by one of ordinary skill in the art. Thus, the broader aspects of the disclosure are not limited to the specific details and representative embodiments presented and described above. Accordingly, various modifications may be made without departing from the spirit or scope of the general inventive concept as defined by the appended claims and their equivalents.

What is claimed is:

1. A charge control device comprising a controller, wherein the controller limits electric power consumption of a battery temperature control actuator to equal to or less than an output limit of a charging station while a vehicle is being charged.
